(19) United States
(12) Patent Application Publication
(10) Pub. No.: US 2009/0040196 A1
(43) Pub. Date: Feb. 12, 2009

(54) Method of controlling the display of various data in a vehicle and Opto-acoustic data unit

(76) Inventors: Bernd Duckstein, Berlin (DE); David Przewozny, Berlin (DE); Siegmund Pastoor, Berlin (DE); Hans Roeder, Berlin (DE); Klaus Schenke, Berlin (DE)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/569,933

(22) PCT Filed: Aug. 24, 2004
(86) PCT No.: PCT/DE04/01870

§ 371 Date: May 15, 2008

(30) Foreign Application Priority Data
Aug. 27, 2003 (DE) 10339314.5

(51) Int. Cl. G09G 5/00

(52) U.S. Cl. 345/204

(57) ABSTRACT

A method and apparatus for controlling the display of various data on a dual view screen in a vehicle in which the line of view of a driver is continually monitored and which in response to the driver directing his line of view to the screen, renders visible to him data relevant to the operation of the vehicle while optionally rendering invisible data not relevant to the operation of the vehicle otherwise viewable only by a passenger.

The invention relates to a method of controlling the display of various data on a common dual view screen by a driver during travel in a vehicle, with the possibility of a passenger observing the dual view screen as well, and to an opto-acoustic data unit in a vehicle for displaying various data on a dual view screen, including a program unit and a display control unit especially for practicing the method.

Such opto-acoustic data units are being used in modern automobiles, for instance, for presenting vehicle guidance and status data (navigation display for presenting data relevant to driving, such as a road map, traffic information, homing guidance data, operational data relating to the vehicle, such as speed and engine temperature), as well as for presenting television images (media display for presenting data not relevant to driving, for instance, video movies, television transmissions, internet pages) and are well known from practical applications in a variety of models. In this connection and as an essential aspect of the opto-acoustic data unit, various methods are being employed for controlling the image on the monitor which differ principally in respect of their convenience to the driver as their main user. Notwithstanding the fact that the following description will often refer to their use in an automobile or, more generally, in actual land-borne traffic, the description does equally refer to traffic upon and in the water and in the air. Wherever it is necessary to find a route and to gather data and to transport passengers, such data units may be used for the increased convenience of a driver and his passengers. Most commonly, however, the screens for navigational indicia and for media presentations separated at the present time. For instance, the media monitors for passengers in the rear seats are installed in the head rests of the front seats, folded down from the roof, or structured as satellites on a flexible arm. For the passenger, the monitor is either foldably installed in the area of a sun visor or removable from an instrument console or dashboard. This entails the risk of limiting the driver's free field of vision and of the driver's attention being inadvertently diverted by the media display. The navigational monitor is usually installed in the center console or it is placed upon the instrument console below the rear view mirror (this arrangement being often offered in connection with after-market systems).

A completely different approach is the use of a common monitor for temporally alternating (selective) navigational and media displays (dual view screen to be distinguished from the appellation of “dual view” in connection with multimedia presentations in the split screen and picture-within-picture mode) which makes possible a selective monitor of the two sources of information in the direction of the driver and of the passenger. In its simplest form, this would be a manual switch in a adapter cable for switching back and forth between the various information sources. As a variant, data units have become known which present data not relevant to driving only when the vehicle is at a stand-still and which, during movement of the vehicle, may continue any associated audio program with its attendant inconvenience to the passenger. German laid-open patent specification DE 197 37 942 A1 discloses a data unit rigidly mounted in the dashboard of a vehicle in which the dual view screen is provided with a liquid crystal element which in a first switching position is pervious to light in a large angular range and which, in a second switching position, is light impervious outside of a small angular range. The large angular range is aimed at both driver and passenger; however, the small angular range is aimed at the passenger only. The displayed image is always visible within the small angular range whereas the large angular range is blanked out when switched off. Only the content of one image can be presented, switching between different image contents must, therefore, take place manually. In order to obtain a particularly great a difference between the light perviousness in the direction of the driver and of the passenger, the energizing voltage of the liquid crystal element may be controlled as a function of temperature. For this purpose, photo sensors for detecting and optimizing the transmitted luminosity by changing the energizing voltage may be arranged within and without the small angular range. The small angular range forces the passenger, in case he wants to watch a movie during the journey, rigidly to position his head which because of occurring driving motions quickly leads to fatigue. Nothing is revealed by the laid-open specification in respect of the method of controlling the monitor, i.e. about switching between the two viewing ranges; it may, however, be assumed, to be a manually actuable electronic switch which may be actuated by either the driver or the passenger. Hence, for possible viewing of data relevant to the journey the driver must perform an action which require corresponding movements and time. This operation is comparable to manually switching on a traffic transmitter in the wireless. This thus leads to diverting the diver's attention from the traffic and a relatively large (and, in an actual decisive situation, a possibly too long) interval of time between the desire or necessity of viewing the data until its presentation. Moreover, the various image contents must constantly be changed.

German laid-open patent specification DE 199 20 789 A1 discloses a data unit which requires no switching and the display of which operates by way of a raster of cylindrical lenses which makes it possible to view two different image contents from different directions. In principle, the methods used in connection with this direction-selective presentation are similar to those applied to the selective presentation of a left and a right stereo in a line raster format in stereoscopic 3D monitors of the kind generally known, so that it constitutes a novel use in the context of simultaneous viewing in an automobile. The difference from the 3D presentation is, however, that the lateral spacing between the two viewing zones is very large (about 70 cm; in stereo presentation the lateral spacing corresponds to an inter-ocular spacing of about 65 mm) with corresponding demands with respect to the rastering. This arrangement suffers from the general disadvantage of a reduced localized image resolution because only half of the pixels of the monitor are respectively available for the navigational presentation and for the media presentation. In a theoretically possible time-sequential directionally selective presentation the image repetition rate for both image contents would have to be halved. For a flicker-free presentation of the two images (more than 60 Hz), this would require special monitors of a very high image repetition rate (more than 120 Hz). This requirement cannot, however, be satisfied by current flat image screens (LCD monitors, plasma image screens, electro-luminescent monitors).

German laid-open patent specification DE 197 46 764 A1 which, as the most closely related prior art, constitutes the basis of the present invention, also discloses an information unit which while based on the principle of a raster of cylindrical lenses can be switched, in which the contents of a rastered image can be viewed from two different viewing directions. It is accomplished by shifting a so-called pre-stressed eccentric lever by means of which the plate of rastered cylindrical lenses can be laterally shifted for deflecting light in different directions. While by presenting the contents of only one image the problem of resolution is reduced, the manual shifting remains problematical which, as stated supra, entails reduced convenience and increased time. Moreover, the shifting of the rastered cylinder plate results only in a changed possible viewing angle; changing the image contents must be carried out additionally. Seen in summary, the prior art discloses methods only and systems for their practice, in which the viewing angle and, independently thereof, the data presented can be set only by deliberately executing the desire at least of the driver. This demands an increased attention of the driver taken from his attention to the traffic with a significantly reduced comfort.

It is thus an object of the invention to provide a method for controlling the image of various data on a common dual view screen which offers the greatest possible comfort to a driver for viewing journey-relevant information. The driver's attention must not be distracted from his task of operating the vehicle by unintentionally viewing the media presentation thus ensuring high driving safety. Furthermore, a possibly passenger is not to be unnecessarily burdened, in a manner impeding his comfort, when viewing data not relevant to driving. The method is to be quick and immune from disturbances in its execution. At the same time, an opto-acoustic data unit for executing the inventive method in particular is to be simple and robust in its construction and operability. Moreover, it and especially the monitor used are to be cost-efficient and accessible to actual media presentations.

The complex of objects may be taken from the two associated claims. Advantageous embodiments have been set forth in respective subclaims and will hereafter be described in greater detail in connection with the invention.

In accordance with the inventive method in a dual view operation, the driver's actual line of view is automatically continually monitored. When detecting that the driver is looking at the dual view screen, journey data relevant to the driver will be displayed immediately. Thus, the driver will have relevant data available at all times without any need for action on his part. He is being observed by the system and may intuitively indicate his decision of wanting to receive data relevant to the journey by selecting the direction in which he is looking. Tests relating to driving safety have shown that the driver has a maximum time of one second for reading the instruments. If longer attention is paid to the instruments, the risk of an accident increases significantly. For a passenger, any interruption of the media presentation, if used, will be limited to short durations so that the method in accordance with the invention ensures a high degree of viewing comfort for the passenger. The display of data relevant to driving each time the driver looks at the dual view screen amounts to an educational process. The driver cannot view any of the data not relevant to driving which is presented to the passenger during phases of his diverted view. It disappears automatically whenever the driver looks at the dual view screen. Hence, the driver's attention is not distracted by his viewing a media presentation, and driving safety is ensured. Tests with navigational systems have also revealed a systematic dependence of the viewing frequency upon the complexity of the actual navigation. In normal circumstances, an interruption of the media presentation while the driver is looking at the dual view screen (short time switching to the navigation mode) does not constitute any great inconvenience for the passenger; after all, common film presentations on television are interrupted by blocks of advertising of much longer duration. At more frequent interruptions, the passenger will forego his media presentation in any event and will want to observe the traffic.

The almost lag-free presentation of journey-relevant data upon the driver's viewing contact with the dual view screen may be achieved by appropriate detection technology. Without any disturbance to him, the driver is being observed by a video camera. The evaluation of the detected images takes place in a binary fashion as a yes or no decision since the system needs only to decide whether the driver is looking at the monitor or not. It is thus possible to achieve data processing in real time. A slight delay then occurs only as a result of the control signal for switching the contents of the image. In the inventive method both data sources are rendered alternatingly visible and make use of the total image resolution of the monitor. Switching between the two data sources takes place automatically depending upon the driver's actual line of view. Because of the selective non-simultaneous displays of the various image contents for the driver and the passenger, the total local resolution of the monitor may be used in the usual orientation of the monitor (landscape format). The method in accordance with the invention can, therefore, be realized in a technically simple manner with commercial components and, compared to conventional approaches regarding dual view displays, it is characterized by the following advantages:
Commercial flat screens may be used.
The dual view screen may be used in a standard landscape image format (4:3; 16:9; . . . ). This is especially advantageous if TV programs or movies in DVD are to be presented for a passenger (because of the vertical orientation of color filter strips, known arrangements with a separation raster in current commercial flat image screens necessitate operation in an unfavorable portrait format).
There is no need for special signal processing such as, for instance, columnar or linear scanning of the images for the driver and passenger.
There is no loss of image resolution and brightness: The driver and the passenger see the total resolution and luminosity of the screen, e.g. 1,024×786 pixels.
There are no such barriers preventing realization as there are in stereo-based approaches owing to the extreme distance to be realized between viewing zones.
The automatic processing operation simultaneously ensures optimum comfort for the driver and driving safety.

In its accomplishment of the method in accordance with the invention the opto-acoustic data unit in addition to a dual view screen, a programming unit for the data to be presented and a screen control unit for executing the requirements resulting from the processing of the data, is also provided with a video-based detector unit for continually and automatically detecting a driver's actual line of view which includes at least a video camera positioned in the immediate proximity of the screen and aimed at the driver, and an evaluation unit for controlling the screen control unit. Hence, the system is simple and cost-efficient as well as suitable as after-market equipment. Preferably, the dual view screen is integrated into the center console of a vehicle. The video camera may be positioned in a frame directly above the screen. Its direct integration into the frame of the screen or—in the case of transparent screens
positioning behind the screen is possible as well.

The automatic switching in the manner of the inventive method prevents the driver from observing distracting image contents. There may, however, be a risk of the driver following the media presentation in his peripheral field of view and of being distracted from observing the traffic. This can be prevented by a direction-selective presentation of the data such that data relevant to driving is presented only to the driver and data not relevant to driving is presented only to the passenger. Such direction-selective illumination is known, for instance, from German laid-open patent specification DE 197 35 177 A1. For its realization a backlighting system having two alternative directions of illumination may be integrated, one being directed to the driver and the other one being directed to the passenger. For its realization a commercial transmission panel (LCD display) with modified backlighting may be used. The technological solution for the direction-selective backlighting preferably consists of two white LED arrays respectively aimed at the driver and the passenger. LED's make possible an almost lag-free activation/deactivation of the illumination; they also have a long service life and are of high efficiency. Activation of journey-relevant data causes immediate activation of the illumination device aimed at the driver. However, during phases of media presentation it is the illumination device aimed at the passenger which is activated with the driver being excluded. However, the illumination device directed to the driver may also cover the passenger so that he may observe data relevant to the journey.

The passenger may select, by a manual actuator, e.g. a simple transfer switch for selective activating, deactivating and changing between various data, whether during interruptions of his media presentation he wants a dark screen or whether he wants to view the navigation display. Moreover, the display control may be removed from the automatic operation and may manually be adequately configured by the driver or the passenger. For instance, the dual view screen may permanently display navigational data if no passenger is on board. During a long journey on a turnpike, with a passenger, the navigational mode may be switched off temporarily in order to prevent unintentional interruptions of film presentations. The automatically controlled switching of the image contents presented may include a permanent display of journey-relevant data if the line of view of the driver cannot be detected. This may happen, for instance, if the natural illumination of the driver is insufficient for image detection (dawn or dusk, driving through a tunnel) or where it is subject to extreme fluctuations (driving along a tree-lined road with laterally impinging sun light). In such circumstances, the passenger will have to tolerate a temporary interruption of his media presentation. Special wishes of customers as to the switching mode in extreme light conditions may be taken into consideration by the software. However, a safe operation of the navigation system may be ensured even in conditions of unfavorable light, and especially during journeys at night, by illuminating the driver with infrared light. For this purpose, an illumination device, more particularly one equipped with an infrared light source, aimed at the driver may be arranged immediately adjacent to the screen. More particularly, the at least one video camera and the illumination device aimed at the driver may be positioned behind a plate pervious to infrared light, preferably, in the area of the screen. Thus a complete system may be commercially provided in which a video camera and an infrared light source are integrated in the rim of the screen. In this manner individual installations and disturbing cable assemblies are avoided.

In addition to an integrated directionally selective illumination system for increasing the traffic safety by reduced distraction of the driver, the method in accordance with the invention may also provide for detecting the duration of the driver's eye contact with the dual view screen and for releasing a warning signal by an acoustic and/or optical warning device in case a predetermined threshold value is exceeded. Tests have shown that a driver of an automobile ought to observe the navigation display or other instruments no longer than for a maximum time of one second. Longer observations lead to significantly increased risks of accidents. By contrast, the mentioned embodiment of the invention significantly lowers the risk of accident compared to present day permanently switched-on navigational displays since upon expiry of one second the driver is acoustically or optically (by a blinking display, for instance) urged to look in the direction of movement. This measure may also be used in connection with a driver assistance system such that the driver is urged vocally to look in the forward direction after looking at the navigation display for too long a time.

The software for the method in accordance with the invention including a video-based recognition of viewing the dual view screen may be pixel-based methods (comparison of image patterns and edge patterns) and characteristics-based methods (detecting and evaluating the position of the angle of the eyes, nostrils, corners of the mouth, etc. or of the pupil and, optionally, additional light reflexes on the cornea). The detection process used is selected so as to be as robust as possible in respect of changes in the ambient illumination (driving in sunlight or at night). In order to adhere to the condition of real time, the algorithm used requires the fewest possible calculations so that it may be implemented on a microprocessor platform. This requirement is augmented by the binary decision pattern of the automatic switching. For use in connection with nighttime driving the driver must be actively illuminated by IR LED's as has already been mentioned. Any evaluation is then by necessity based exclusively on the use of intensity images without natural color data.

For explaining the further selection of software and the invention, the operation of the method in accordance with the invention in its automatic mode will be described in the specific description on the basis of embodiments with reference to drawings, in which:

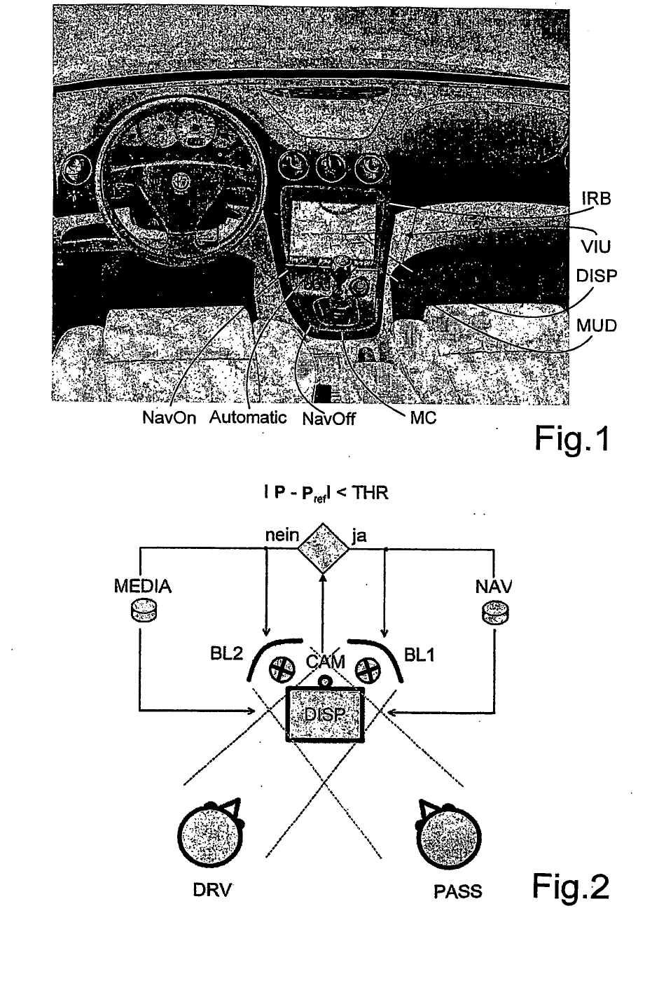

FIG. 1 is a data unit for practicing the method in accordance with the invention installed in an automobile;

FIG. 2 is a block diagram of the basic principle of the method in accordance with the invention;

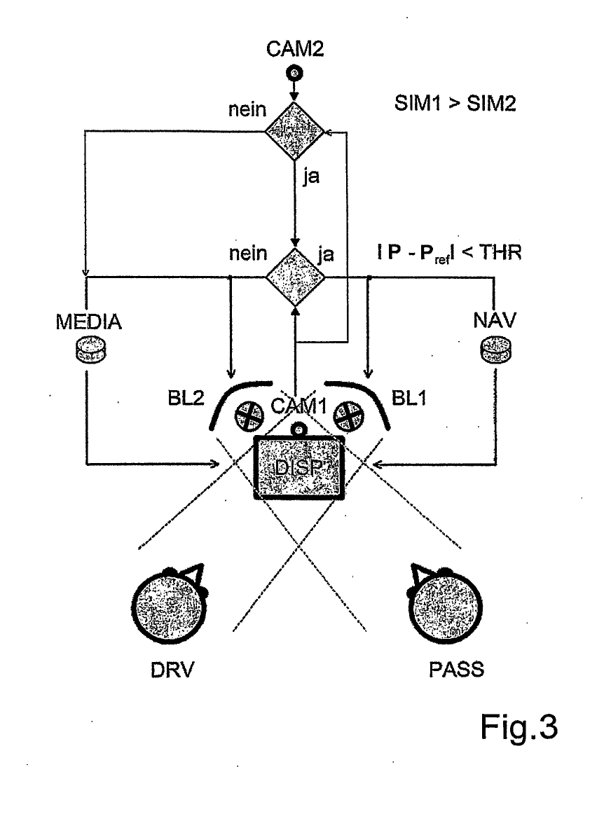

FIG. 3 is a block diagram of the method in accordance with the invention with an additional camera;

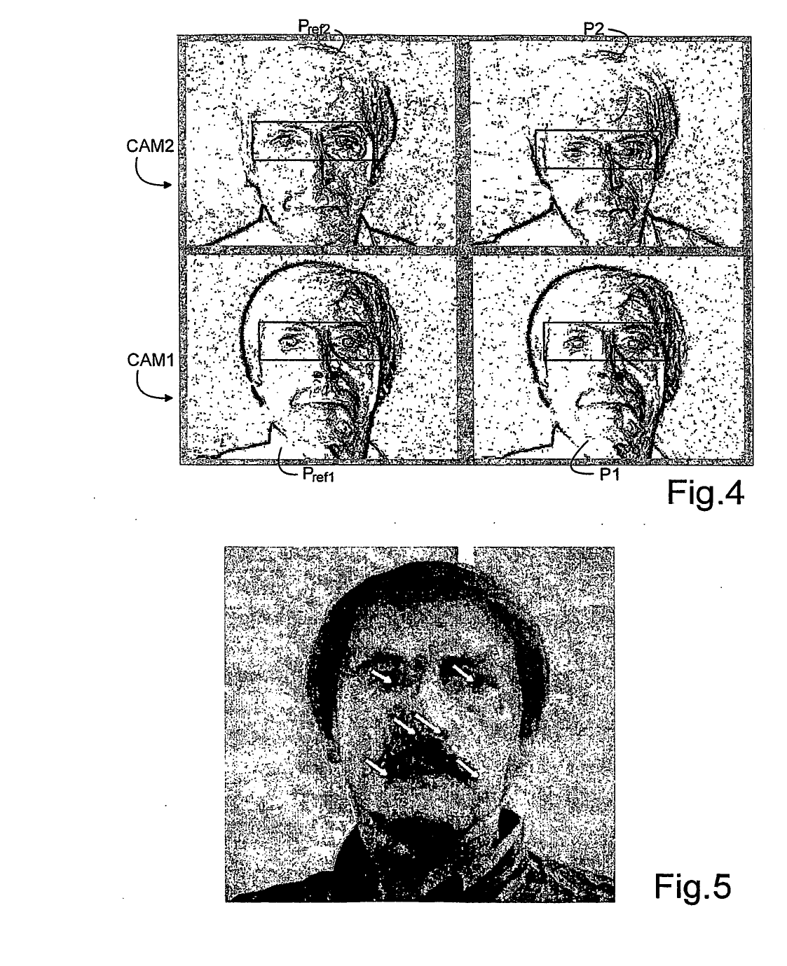

FIG. 4 depicts edge images as reference and actual images;

FIG. 5 depicts examples of motion vectors;

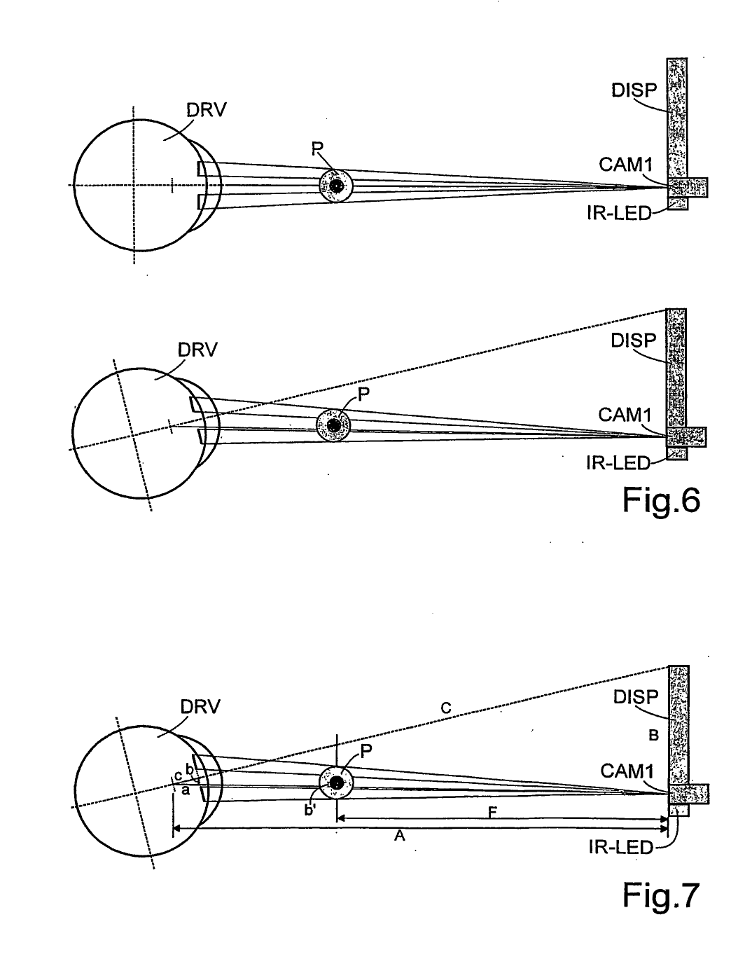

FIG. 6 shows the measurements in a simplified cornea reflex method; and

FIG. 7 depicts the calculations of the tolerance value for the simplified cornea reflex method.

FIG. 1 is a photomontage showing an arrangement of a visually controlled data unit VIU in accordance with the invention, with a dual view screen DISP in the center console MC of an automobile. Infrared LEDs and a video camera are arranged behind a frame IRB pervious to infrared light above the dual view screen DISP. Selecting different operational modes, e.g. “Navigation permanently on” NavOn, “automatic switching operation” Automatic and “navigation permanently off” NavOff is made possible by various switches of a manual operating device MUD. The switches may be simple mechanical push buttons or they may be integrated in the screen as freely configured touch screen elements. Further functional elements are arranged below the dual view screen DISP and are not shown in the drawing.

The initialization and operation of the visual control as essential basic principles of the method in accordance with the invention will be described hereafter. In natural vision small changes in the viewing direction are brought about by a corresponding rotation of the eye ball relative to the head. At greater viewing movements or when looking at in a given direction for an extended duration, the entire head is additionally rotated in the direction of the object viewed. Known methods of measuring the viewing direction aim at a stable measurement of the direction of the visual axis, i.e. the actual rotational angle of the eye ball relative to an external reference object, within as large a range of angular vision as possible (cornea reflex method, see DE 199 53 835 C1 and the references cited therein), or to detect minimal viewing movements relative to the disposition of the head (limbus tracking method, see DE 199 53 835 C1 and the references cited therein). In contrast to known vision measuring methods the method in accordance with the invention here described relates to making a yes/no decision with respect to a selected object (the screen) looked at, at low complexity and low susceptibility to malfunction. For that reason, the preferred embodiment of the implemented detection method may be based upon the evaluation of a sum of externally visible visual characteristics which can be detected by a camera and which allow an inference of being observed. In this connection, the comparison with a reference image represents the basic principle (see FIG. 2). Before starting a journey, the driver activates the dual view screen by a pushbutton in the immediate vicinity of the screen. At the same instant, the camera positioned in the immediate vicinity of the monitor takes an image of the driver which is stored as a reference image for the viewing direction to be detected. During the journey the reference image is compared with actual video images for recognizing viewing in the direction of the dual view screen.

A value of similarity is determined during the image comparison. The value may be calculated by comparing the intensity within a predetermined range of the pixels (preferably a block of pixels which includes the area of the eyes). In a first step, the predetermined range is looked for by a block matching process in the actual camera image P (by comparing the intensity values in image blocks of the reference image P_{ref} and of the actual or instantaneous camera image P). For the best match, the summed absolute differences of the intensity values in the corresponding blocks of the actual image P and of the reference image P_{ref} are thereafter combined to a similarity value. In order to render the process substantially immune from changes of the ambient light, it may be advantageous to operate with image contours rather than with intensity values which are highly illumination-dependent. For this purpose, the significant contours in the reference image P_{ref} and in the instantaneous video image P are extracted by means of edge operators (e.g. the “Canny Edge” Detector or the “Sobel” Operator). Thereafter, a similarity value is determined for the best match by the process described supra, but on the basis of the edge images. If the similarity value thus determined reaches a predetermined similarity threshold (threshold value THR), a signal is released which switches the image source of the screen DISP from the media source MEDIA to the navigation display NAV. At the same time, the backlighting BL1 of the screen DISP directed towards the driver DRV is switched on. As soon as the driver DRV moves his head/view away from the dual view screen DISP, the backlighting BL1 is turned off and the media source MEDIA is turned on.

The basic principle of a vision controlled data unit VIU with a dual view screen DISP broadened by a directed backlighting is depicted as a block diagram in FIG. 2. If the reference image P_{ref} and the instantaneous or actual camera image P from the video camera CAM of the driver DRV are sufficiently similar (the difference is less than a threshold value THR, yes/no decision) it is assumed that the driver is looking at the screen DISP. In that case the navigation display NAV is switched through to the dual view screen DISP and the backlighting BL1 aimed at the driver DRV is switched on. The backlighting BL2 for the passenger PASS and the media source MEDIA are temporarily switched off.

The methods described hereafter serve reliably to distinguish the viewing of the driver of the dual view screen from looking at objects in the vicinity of the journey (when looking through the windshield) or in the car (viewing the rear view mirror and other instruments). Directional views requiring a lateral rotation of the head and of the eyes comparable to directing the view to the dual view screen (same azimuthal disposition) are particularly critical.

The first modified method includes a cross check by an additional camera. An additional video camera CAM2 (see FIG. 3) is preferably mounted below the internal rear view mirror in the same azimuthal disposition (relative to the head of the driver) as the video camera CAM1 of the dual view screen DISP. During initial calibration of the system, a reference image P_{ref1} is taken when the driver is looking in the direction of the video camera CAM1 as well as a reference image P_{ref2} when the driver is looking at video camera CAM2. During operation, two similarity values SIM1 and SIM2 are detected by comparing the actual or instantaneous camera images P1 and P2 with the associated reference images P_{ref1}, and P_{ref2}. The calculation for the two signal sources is carried out in accordance with one of the processes described supra. Only when video camera CAM1 delivers a better similarity value than video camera CAM2 (SIM1>SIM2) and provided this similarity value reaches the predetermined similarity threshold value THR, is it assumed that the dual view screen DISP is being looked at.

FIG. 4 depicts the edge images of the upper camera CAM2 disposed in the area of the rear view mirror and of the lower camera CAM1 disposed in the area of the dual view screen DISP (the reference image P_{ref1}/P_{ref2} at the left and the actual image P1/P2 at the right) with the driver DRV looking at the dual view screen DISP, i.e. in the direction of the video camera CAM1. The rectangles shown indicate the block borders in the region of the eyes required for calculating the similarity values SIM1 and SIM2. It can be seen that the upper blocks deviate significantly from each other and that the lower blocks are very similar to each other. In that case the method in accordance with the invention signals that the dual view screen DISP is being looked at and initiates the corresponding modifications.

The evaluation of movement vectors (visual flow) (see FIG. 5) constitutes another method of improving the certainty of detection. The methods thus far described evaluate static image characteristics for detecting a possible direction of view. However, the reliability of the method in accordance with the invention can be still further improved by taking into consideration the natural course of movements while directing the line of view (dynamic gesture of directing the line of view by rotation of the head and of the eyes, movement of the eye lids). For this purpose, chronologically sequential images of one or both of the video cameras are analyzed by methods of estimating vectors of movement (visual flow). Such methods are known, for instance, in connection with digital image data compression (e.g. the movement compensated prediction during data compression according to MPEG-2) and digital format conversion )movement adaptive local/chronological image interpolation). Real time hardware solutions already exist for estimating movements—mostly on the basis of a block matching method. Given the geometry of recording to be known (position of the video cameras, of the dual view screen and of the driver) and assuming that the driver is looking in a forward direction most of the time, a potential viewing direction may be assumed simply on the basis of the direction of the vectors of movement. The result of the movement vector estimate may be used in connection with an evaluation of static image characteristics within the context of a consistency test for improving the reliability of detecting the viewing direction. The movement vectors tend to move downwardly (negative average value of the vertical component of the vectors) when the line of view is directed to the dual view screen arranged within the center console.

Further methods of definition are based upon direct view measurements. The methods described thus far make it difficult to detect the viewing direction by eye movements alone, without a perceptible rotation of the head. Directing the line of view in this manner may be expected particularly if the dual view screen is mounted at a higher position (within or on top of the main instrument panel), rather than in the center console. In that case a simplified version of the known cornea reflex method (see DE 199 53 835 C1 and the references there cited) will be applied. The simplified version provides for positioning light emitting diodes necessary for generating a light reflex in the immediate vicinity of the camera axis. In that manner, the pupil will appear in the image plane of the camera as a light spot (comparable to the red eye effect in flash photography); moreover, when looking at the camera, the light reflex is located in the center of the image of the pupil and may be localized there by an intensity threshold value operation (see FIG. 6).

In the embodiment schematically shown in FIG. 6, the dual view screen DISP is positioned immediately above the video camera CAM1 measuring the view. Infrared light emitting diodes IR-LED are arranged immediately below the video camera CAM1. In the upper presentation of FIG. 6 the driver DRV is looking directly toward camera and the dual view screen DISP. The camera image of the driver's DRV eye EYE displays a reflex spot in the center of the cornea of the eye including the iris and the pupil. In the lower presentation of FIG. 6 the driver's line of view is directed to a side of the dual view screen DISP. The reflex point away from the center of the cornea can be clearly seen in the corresponding camera image P.

For detecting the direction of view toward the dual view screen DISP it is thus possible to state a tolerance range which is largely defined by the imaging geometry and in which the light reflex must be positioned relative to the center of the pupil when the driver is looking at the dual view screen. FIG. 7 depicts the calculation of a tolerance value b′ for a given imaging geometry under the assumption of generally known Gullstrand values for a schematic average eye. The application here described is distinct from the known cornea reflex method in that it requires no individual calibration of the measuring process. It proceeds instead from Gullstrand's average eye and simply measurable parameters of the technical structure which significantly simplifies the method of detection. For further simplification it is assumed that the eye EYE rotates about the center of curvature of the cornea. The sought tolerance value b′ is thus calculated on the basis of the radiation beam theorem as follows:

b′=c·B/C·F/A

where
A=the distance of the measuring video camera (main plane) from the eye of the driver (e.g. 70 cm)
B=the distance of the rim of the screen from the optical axis of the video camera
C=the distance of the rim of the screen from the eye of the driver (≅A)
c=the distance of the plane of the pupil from the center of curvature of the cornea (4.1 mm according to Gullstrand)
F=the distance of the (fictitious) image plane of the video camera from the center of the lens (≅focal length, e.g. 4 mm) and
b′=the distance of the light reflex from the center of the pupil in the camera image.

### LIST OF REFERENCE CHARACTERS

A distance CAM/EYE
b′ tolerance value
B distance rim DISP/CAM
BL1 backlighting DRV
BL2 backlighting PASS
c distance pupil plane/center of curvature of the cornea
C distance rim DISP/EYE
CAM video camera
DISP dual view screen
DRV driver
EYE eye of driver
F distance image plane CAM/center of lens
IRB infrared light pervious frame
IR-LED infrared light emitting diode
MEDIA media source
MC center console
MUD manual operating device
NAV navigation display
P actual camera image
P_{ref} reference image
PASS passenger
SIM similarity value
THR threshold value for similarity value SIM
VIU vision controlled data unit

What is claimed is:

1. A method of controlling the display of various data on a common duel view screen by the driver during a journey in a vehicle with a possible passenger being also able to observe the dual view screen, characterized by the fact that
the actual direction of view of the driver (DRV) is continually detected and that data (NAV) about the journey relevant to the driver is displayed substantially without delay only when the driver (DRV) is in eye contact with the dual view screen (DISP) whereas during intervals without eye contact data not relevant to the journey can alternatively be displayed, the actual line of view being detected by a video-based detection of the rotation of the head and/or movement of the eye of the driver (DRV) on the basis of a static or dynamic method of detection and that in the evaluation only a binary decision (THR) is made whether the driver (DRV) is actually viewing the dual display screen (DISP) or not.

2. The method in accordance with claim 1,
characterized by the fact that
the data is displayed direction-selectively, the data (NAV) relevant to the journey being displayed to the driver (DRV) only and the data (MEDIA) not relevant to the journey being displayed to the passenger (PASS) only.

3. The method in accordance with claim 1,
characterized by the fact that
the data (NAV) relevant to the journey is displayed permanently only if the driver's (DRV) actual line of view cannot be detected.

4. The method in accordance with claim 1,
characterized by the fact that
that the detection method operates on the basis of pixels or characteristics.

5. The method in accordance with claim 1,
characterized by the fact that
as a static detection method the cornea reflex method is used for the stable measurement of as large a viewing angle range as possible or the limbus tracking method is used for detecting a minimum relative viewing movement.

6. The method in accordance with claim 5,
characterized by the fact that
a simplified cornea reflex method is used in which the pupil is a detected as a bright spot and a corresponding tolerance range is defined for the position of the light reflex on the cornea.

7. The method in accordance with claim 1,
characterized by the fact that
a difference-forming comparison of similarities between a reference image (P_{ref}) in which the driver (DRV) is viewing the dual view screen (DISP) and an actual image (P) is carried out and a similarity value (SIM) is determined, the binary decision being made in dependence of a predetermined threshold value (THR) for the detected similarity value.

8. The method in accordance with claim 7,
characterized by the fact that
the similarity value (SIM) is determined in a predetermined range using a block matching process or with values of intensity or edge operators.

9. The method in accordance with claim 1,
characterized by the fact that
the dynamic detection method is based upon the evaluation of movement vectors, especially by applying a block matching process.

10. The method in accordance with claim 1,
characterized by the fact that
that the display may also be controlled manually.

11. The method in accordance with claim 1,
characterized by the fact that
the duration of the visual contact established by the driver (DRV) with the duel view screen (DISP) is detected and that above a predetermined threshold value a warning signal, a warning notice or a request is issued to the driver.

12. The method in accordance with claim 1,
characterized by the fact that
the driver (DRV) is actively illuminated, especially with infrared light (IR-LED).

13. The method in accordance with claim 1,
characterized by the fact that
the video-based detection is based upon video images at two different recording sites, one of the recording sites corresponding to the position of the dual view screen (DISP) and the other site being arranged azimuthally therabove, and that reference images (P_{ref}) are formed of from both recording sites.

14. An opto-acoustic data unit in a vehicle for displaying various data on a dual view screen with a program unit and a display control unit, particularly for practicing the method in accordance with one of claims 1 to 9,
characterized by the fact that
there are provided a video-based detector unit for the continual automatic detection of the actual direction of view of the driver (DRV) with at least one video camera (CAM) arranged in the immediate vicinity of the dual view screen (DISP) and an evaluation unit controlling the display control unit.

15. The opto-acoustic data unit in accordance with claim 14,
characterized by the fact that
the dual view screen (DISP) is integrated into the center console (MC) of the vehicle.

16. The opto-acoustic data unit in accordance with claim 14,
characterized by the fact that
the dual view system (DISP) is structured as a flat screen, especially in the landscape format.

17. The opto-acoustic data unit in accordance with claim 14,
characterized by the fact that
a switchable backlighting system (BL1, BL2) for presenting the various data with two alternative directions of illumination one of which is directed to the driver (DRV) and the other one being directed to the passenger (PASS) is integrated into the dual view screen (DISP).

18. The opto-acoustic data unit in accordance with claim 14,
characterized by the fact that
there is provided a manual operating unit (MUD) for selectively activating, deactivating and switching between various data.

19. The opto-acoustic data unit in accordance with claim 14,
characterized by the fact that
there is provided an acoustic and/or optical warning device.

20. The opto-acoustic data unit in accordance with claim 14,
characterized by the fact that
an illumination device (BL1) especially with infrared light sources (IR-LED) aimed at the driver (DRV) is arranged in the immediate vicinity of the dual view screen (DISP) and/or the video camera (CAM).

21. (canceled)

22. (canceled)

23. (canceled)
